(19) United States
(12) Patent Application Publication
(10) Pub. No.: US 2026/0049628 A1
(43) Pub. Date: Feb. 19, 2026

(54) SYSTEM AND METHOD FOR COUPLING STRUCTURAL MEMBERS WITH TOLERANCES

(71) Applicant: REE AUTOMOTIVE LTD, KIBBUTZ GLIL YAM (IL)

(72) Inventors: Gil HACOHEN, Ramat Efal (IL); Amnon SHKEDY, Tel Aviv (IL)

(21) Appl. No.: 19/101,913

(22) PCT Filed: Aug. 17, 2023
(86) PCT No.: PCT/IB2023/058256

§ 371 Date: Feb. 7, 2025

Related U.S. Application Data
(60) Provisional application No. 63/371,640, filed on Aug. 17, 2022.

(51) Int. Cl. F16B 5/02; B62D 27/02

(52) U.S. Cl. CPC F16B 5/02; B62D 27/023

(57) ABSTRACT

A system for adaptive coupling of two structural members comprises a first eccentric hollow bush having a cylindrical outer surface and a cylindrical inner hole with an axis that is eccentric relative to the first-bush outer surface, and a second eccentric hollow bush having a cylindrical outer surface and a cylindrical inner hole having an axis that is eccentric relative to the second-bush outer surface. When the system is in an unlocked and assembled state, the second bush is disposed within the inner hole of the first bush such that its outer surface faces the first bush inner hole, the first bush is inserted in respective opposing fixturing holes of the two structural members such its outer surface faces the fixturing holes, and the first second bushes are respectively rotatable about the first and second eccentric axes.

### FIELD OF THE INVENTION

The present invention relates to the field of coupling structural members, and more particularly, to coupling structural members to others when having tolerances in at least one dimension.

### BACKGROUND

In many applications there is a need to connect two structural members together, for example to connect a sub-frame to a main frame by applying fasteners via mating holes. Due to inaccurate manufacturing, assembly requirements, and high tolerances build ups, there is often a need to free tolerances that would allow the connection of the structural members. Usually, to reduce costs and ensure the fit of the structural members, the solution is to enlarge the mating holes and tie between the structural members using fasteners such as screws, bolts, nuts and washers. Such method will have the connection between the structural members using friction forces running between the body of the structural members and the fasteners. It may be desirable to fit the fasteners within the mating holes to connect between the structural members using shear forces in addition to the friction forces.

### SUMMARY OF THE INVENTION

According to some embodiments of the invention, a system for coupling two structural members comprises: a first eccentric hollow bush comprising a cylindrical first-bush outer surface and a cylindrical first-bush inner hole having a first eccentric axis, the first eccentric axis being eccentric relative to the first-bush outer surface, and a second eccentric hollow bush comprising a cylindrical second-bush outer surface and a cylindrical second-bush inner hole having a second eccentric axis, the second eccentric axis being eccentric relative to the second-bush outer surface. When the system is in an unlocked assembled state, (i) the second bush is disposed within the first-bush inner hole such that the first bush inner hole faces an outer surface of the second bush, (ii) the first bush is inserted in respective opposing fixturing holes of the two structural members such that the first-bush outer surface faces the fixturing holes, and (iii) the first bush is rotatable about the first and second fixturing holes axes and the second bush is rotatable about the first eccentric axis.

According to some embodiments, when the system is in the unlocked assembled state, a rotation of both the first and the second bushes can change the location of both the first eccentric axis and the second eccentric axis.

According to some embodiments, the system can be effective to reduce a total tolerance relative to a combined manufacturing tolerance of respective fixturing holes of the two structural members.

According to some embodiments, the system can comprise respective first and second locking members for placing the first and second bushes in a locked state in which the first bush and second bushes are un-rotatable with respect to the fixturing holes.

According to some embodiments, at least one of the first and second bushes can comprise a non-circular head. According to some embodiments, the locking member can comprise a non-circular locking aperture.

According to some embodiments, at least one of the first and second locking members can have a portion open for sliding sideways onto a respective one of the first and second bushes for locking a rotation of the respective one with respect to the fixturing holes.

According to some embodiments, the system can comprise a locking disk adapted to fit within at least one of the two respective fixturing holes, the locking disk having a locking disk hole for receiving one or more portions of a disk fastener, wherein when the system is in the assembled state, the disk fastener locks the locking disk to be un-rotatable with respect to the first and/or the second bush.

According to some embodiments, it can be that (i) the at least one fixturing hole has an internal step, and the locking disk fits within the at least one fixturing hole such that the internal step constrains the locking disk from moving in a direction parallel to the first and the second eccentric axes.

According to some embodiments, the inner hole of the first bush has an internal thread and the outer surface of a second bush has an external thread, such that the first and second bushes are threadedly couplable to each other to adapt a respective position with respect to each other along a direction parallel to the first and second eccentric axes.

According to some embodiments, when the system is in the assembled state, the locking disk is fastened to the first bush.

According to some embodiments, a first of the two structural members can comprise a sub-frame and comprises a positioning fixturing hole, an oval-shaped attachment hole, and the fixturing hole.

According to some embodiments of the invention, a system for adaptive coupling of two structural members comprises: a first eccentric hollow bush comprising a conical first-bush outer surface and a cylindrical first-bush inner hole having a first eccentric axis, the first eccentric axis being eccentric relative to the first-bush outer surface; and a second eccentric hollow bush having a conical second-bush outer surface and a conical second-bush inner hole having a second eccentric axis, the second eccentric axis being eccentric relative to the second-bush outer surface. A minimum diameter of the second-bush outer surface is bigger than a minimum diameter of a conical fixturing hole, a maximal diameter of the first bush outer surface is bigger than a maximum diameter of the second bush inner hole, and when the system is in an unlocked assembled state, (i) the first bush is assembled within the second bush inner hole such that the conical first-bush outer surface faces the conical second-bush inner hole; (ii) the second bush is inserted in respective opposing fixturing holes of the two structural members, such that the conical second-bush outer surface faces the fixturing holes, and (iii) the first bush is rotatable about the second bush eccentric axis and the second bush is rotatable about the conical fixturing hole axis.

According to some embodiments, the system can be effective to reduce a total tolerance relative to a combined manufacturing tolerance of respective fixturing holes of the two structural members.

According to some embodiments, the first bush outer surface can have substantially the same slope, or is within ±5% or ±10% of having the same slope, as the second bush inner hole, and the second bush outer surface can have substantially the same slope, or is within ±5% or ±10% of having the same slope, as at least one respective fixturing hole.

According to some embodiments, it can be that when the system is in the assembled state, the first bush is pressed within the second bush in a direction parallel to the second eccentric axis until the first bush outer surface is urged against the inner hole of the second bush, and the second bush is urged against at least one respective fixturing hole, such that the first bush and second bush are locked from being rotatable about their respective eccentric axes.

According to some embodiments, the system can comprise a pin having a first portion with an internal thread and adapted to be inserted within the first-bush inner hole. According to some embodiments, a second portion of the pin can be is fixed to a chassis.

According to some embodiments, the system can comprise a fastener with an external thread shaped for insertion into a hollow portion of the pin. According to some embodiments, the fastener can have a shoulder adapted to push the first bush within the second bush inner hole in the direction parallel to the second eccentric axis. According to some embodiments, the system can comprise a washer disposed between the fastener shoulder and the first bush.

According to some embodiments, when the system in an unlocked assembled state, the respective locations of the first and second eccentric axes change when the first and second bushes are rotated.

According to some embodiments, the system can comprise a round wire connecting the first bush to the second bush, and a groove on the first bush configured for receiving the round wire.

According to some embodiments, a frame can comprise a first positioning hole, an oval-shaped hole, and one or more fixturing holes in accordance with any of the embodiments disclosed hereinabove.

A method is disclosed, according to some embodiments of the invention, for coupling structural members employing the system according to any of the foregoing embodiments thereof. The method can comprise: inserting a first bush into a second bush inner hole; inserting the second bush into a base portion of the first structural member; placing a pin above the base; rotating the first and second bushes to allow an axis of the pin and the first-bush axis to align; inserting the pin into the first bush inner hole; and screwing a fastener into the pin to lock the system.

According to some embodiments, the round wire can connect the first bush to the second bush. According to some embodiments, the washer can be inserted between the fastener and the first bush.

A method is disclosed, according to some embodiments of the invention, for coupling a sub frame to a chassis, wherein the chassis comprises one or more pins, and the sub-frame comprises the system according to any of the foregoing embodiments thereof. The method cam comprise: placing the pins above the sub-frame; inserting a first pin into a first hole of the sub-frame; rotating the sub-frame until a second pin aligns with a second hole of the sub-frame; for each additional hole of the sub-frame, rotating the first and second bushes to allow an axis of a corresponding pin and the axis of the first bush to align; and screwing a respective fastener into each pin to lock the sub-frame into the chassis. According to some embodiments of the method, the system can be configured to enable reversing the locking.

### BRIEF DESCRIPTION OF THE DRAWINGS

In the accompanying drawings:

FIG. 1 is a side view schematic illustration of two structural members connected by a fastener;

FIG. 2A is a top view schematic illustration of an eccentric bush and a possible location of its axis according to some embodiments of the invention;

FIG. 2B is a top view schematic illustration of an inner and an outer eccentric bushes, according to some embodiments of the invention;

FIG. 3A is three-dimensional (3D) diagrams of a fixturing mechanism, according to some embodiments of the invention;

FIG. 3B is a section view of the fixturing mechanism shown in FIG. 3A;

FIG. 3C is an exploded view of the fixturing mechanism shown in FIGS. 3A-3B;

FIG. 4A, is a three-dimensional (3D) diagram of a fixturing mechanism having z axis adjustment, according to some embodiments of the invention;

FIG. 4B is exploded view of the fixturing mechanism shown in FIG. 4A;

FIG. 4C is a section view of the fixturing mechanism shown in FIG. 4A;

FIGS. 5A and 5B are schematic views of a locking member, according to some embodiments of the invention.

FIG. 6A, is a three-dimensional (3D) diagram of a fixturing mechanism, according to some embodiments of the invention;

FIG. 6B is a sectional view of the fixturing mechanism shown in FIG. 6A;

FIG. 6C is an exploded view of the fixturing mechanism shown in FIG. 6A;

FIG. 7 is a schematic illustration of a frame comprises four holes which two of them include a fixturing mechanism according to some embodiments of the invention; and

FIG. 8 is a schematic illustration of a chassis comprises the frame shown in FIG. 7, according to some embodiments of the invention.

FIG. 9 is a flowchart of a method of coupling structural members, according to some embodiments of the invention.

FIG. 10 is a flowchart of a method of coupling a sub frame to a chassis, according to some embodiments of the invention.

### DETAILED DESCRIPTION OF THE INVENTION

This patent application claims priority to US provisional patent application Ser. No. 63/371,640 filed on Aug. 17, 2022, which is incorporated herein by reference in its entirety.

The present invention relates to the field of coupling structural members, and more particularly, to coupling structural members to others when having tolerances in at least one dimension. The invention is herein described, by way of example only, with reference to the accompanying drawings in order to provide a thorough understanding of the present invention.

With specific reference now to the drawings in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. However, it will also be apparent to one skilled in the art that the present invention can be practiced without the specific details presented herein. The dimensions of components and features shown in the figures are chosen for convenience and clarity of presentation and not necessarily to scale.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

As used herein and in the claims appended hereto, the term ‘fixturing’ means for use in connecting, attaching, joining, and the like, of two or more mechanical elements or of one mechanical element to another. The expression ‘fixturing mechanism’ means a coupling system, e.g., a mechanical apparatus or assembly, for use in, or for assisting in, the connecting, attaching, joining, etc., of two or more mechanical elements, regardless of whether the connecting, attaching, joining, etc., is permanent or reversible. The terms ‘fixturing mechanism’ and “coupling system” are interchangeable. The expression ‘fixturing hole’ means a hole in a mechanical element for use in, or for assisting in, the connecting, attaching, joining, coupling etc., of two or more mechanical elements, regardless of whether the connecting, attaching, joining, etc., is permanent or reversible.

A ‘structural member’, as the term is used herein and in the claims appended hereto, is a mechanical element such as, for example, a chassis or sub-frame of a vehicle.

Unless otherwise specified, an ‘axis’is an axis of rotation.

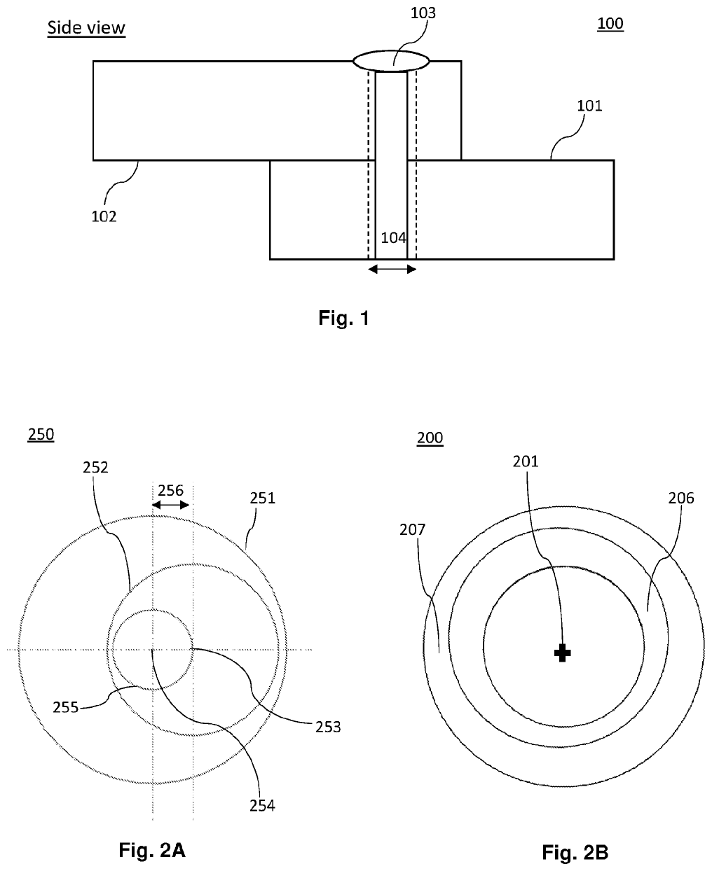

Reference is now made to FIG. 1 which is a side view schematic illustration of two structural members fixed to each other by a fastener.

As shown in FIG. 1, a first structural member 101 and a second structural member 102 are connected to each other by a fastener 103 through a fixturing hole 104. To ensure that the fastener 103 will fit into a fixturing hole 104, a typical solution is to enlarge fixturing hole 104 as shown in FIG. 1. With this typical solution the resistance to loads between the two structural members is mostly by friction forces. Due to tolerances between fastener 103 and fixturing hole 104 the fastener 103 does not take much of shear forces which may make the connection between the two structural members 101/102 stronger than a connection using friction force only.

Increasing the contact surface between fixturing hole 104 and fastener 103, for example by having the body of fastener 103 filling the fixturing hole 104 may improve the attachment of the structural members. To ensure the fitting of fastener 103 and fixturing hole 104 and to ensure shear forces transfer between the structural members, there is a need for high accuracy manufacturing of the structural members. This manufacturing process may increase manufacturing time and cost.

To overcome these problems, according to embodiments, eccentric bushes are located one inside the other. The term “bush” used herein refers to a type of bearing, also known as a bushing. An “eccentric bushing” is a bushing with an off-center mounting hole. As a result, it can a smaller outside diameter on one side than the other, which can have a more extended lip. That kind of bushes allows the fixturing hole to change its location in accordance with the orientation of the eccentric bushes on one or more planes.

Reference is now made to FIGS. 2A and 2B which are two-dimensional (2D) (top-view) diagrams of two eccentric bushes. Bush 250 as shown in FIG. 2A is an example of an eccentric bush, and FIG. 2A shows a possible location of its central axis 253. An outer surface 251 has a main axis 254. An inner hole 252 has an eccentrically located axis 253. All the possible locations of the inner-hole axis 253 are defined by a circle 255. The radius of circle 255 is defined by an offset 256 of the inner-hole (eccentric) axis 253 from the main axis 254.

FIG. 2B shows an example of two eccentric bushes 206 and 207 disposed one inside another. The possible location of bush axis 201 are defined by the possible locations of an eccentric axis of second bush 207 relative to an axis of a fixturing hole in which two eccentric bushes 206 and 207 are inserted and can swivel. For example, fixturing hole 307 or conical fixturing hole 607 as shown hereinafter, and all the possible locations of an eccentric axis of first bush 206 relative to the axis of second bush 207 when eccentric bush 206 and eccentric bush 207 swivel one with respect to another.

By rotating each of bushes 207, 206 one with respect to each other, the location of bush axis 201 will change. It means that the location of bush axis 201 is dynamic and allows to free tolerance for positioning of a fastener into the inner hole of first bush 206.

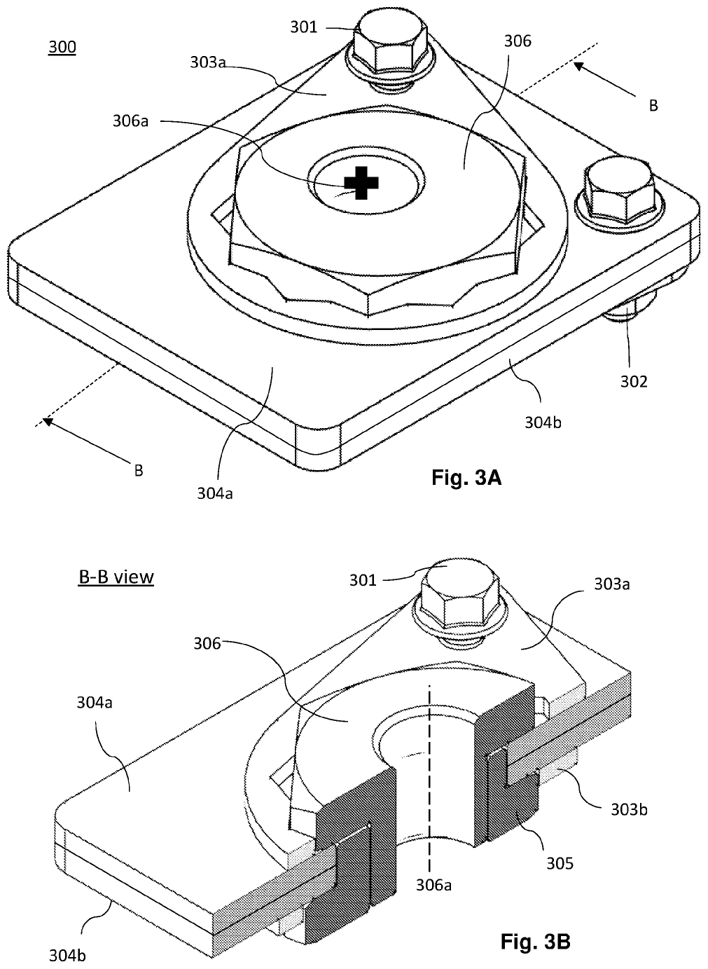

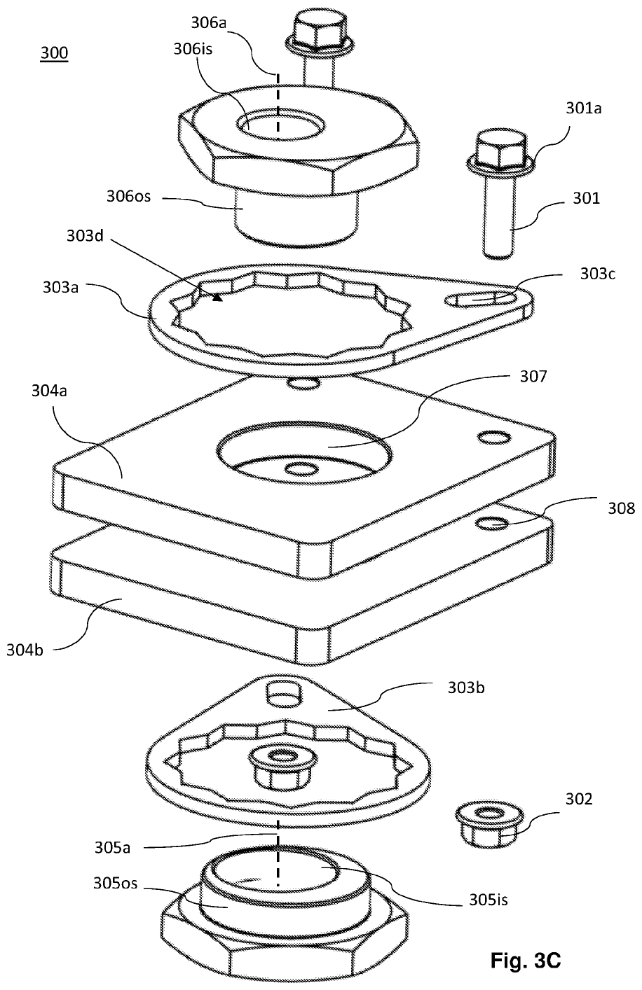

Reference is now made to FIGS. 3A, 3B and 3C which are three-dimensional (3D) diagrams showing a non-limiting example of a fixturing mechanism 300, according to some embodiments of the invention. FIG. 3A shows a perspective view of fixturing mechanism 300. FIG. 3B shows a perspective partial longitudinal section view B-B of fixturing mechanism 300 along line BB of FIG. 3A. FIG. 3C shows an exploded view of fixturing mechanism 300.

Fixturing mechanism 300 may be a mechanism that allows to free tolerance on coupling of applications that need to free tolerance on a plane due to inaccurate manufacturing and high tolerance build ups.

A fixturing mechanism 300 (a ‘coupling system’) may be used for joining a first structural member 304a and a second structural member 304b by accommodating one or more components of fixturing mechanism 300. First structural member 304a and second structural member 304b may be respective portions or parts of two or more structural members intended to be coupled, for example in the case of connecting, attaching, mounting, or coupling a sub-frame to a chassis, e.g., of a vehicle. The connection between the two structural members 304a, 304b may be a permanent connection or a reversible connection. Fixturing mechanism 300 may include a first bush 305 and a second bush 306. According to embodiments, first bush 305 and second bush 306 are eccentric hollow bushes. In some embodiments, first bush 305 has an outer surface 305os and a cylindrical inner hole 305is having a first eccentric axis 305a relative to first bush outer surface 305os. In some embodiments, second bush 306 has an outer surface 306os and a second bush inner hole 306is comprises a second eccentric axis 306a relative to the second bush outer surface 306os. In some embodiments, first bush outer surface 305os is shaped and sized to face a fixturing hole 307 and a first bush inner hole 305is is shaped and sized to face of a second bush 306 when inserted inside each other.

By rotating first bush 305 and second bush 306 with respect to one another, the position of eccentric axis 306a changes. It means that the location of eccentric axis 306a may be dynamic and allows the freeing of tolerance on a plane.

According to some embodiments, as shown in FIGS. 3A-3C, adaptive fixturing mechanism 300 is adapted to fit within a fixturing hole 307 defined within first structural member 304a and second structural member 304b.

Adaptive fixturing mechanism 300 is configured to fix structural member 304a to structural member 304b when having tolerances in at least one dimension of structural member 304a and/or structural member 304b.

According to some embodiments, adaptive fixturing mechanism 300 has an unlocked assembled state wherein second bush 306 is assembled within first bush inner hole 305is and first bush 305 is inserted within fixturing hole 307, such that first bush outer surface 305os facing fixturing hole 307 and first bush inner hole 305is facing outer surface of a second bush 306os and both first bush 305 and second bush 306 are each rotatable about their respective eccentric inner fixturing hole axes.

According to some embodiments, adaptive fixturing mechanism 300 further includes a locked state to lock the correct position of eccentric axis 306a. According to some embodiments, adaptive fixturing mechanism 300 has one or more locking members 303 for placing first bush and/or second bush in a locked state in which one or more of the following applies: (i) first bush 305 is un-rotatable with respect to fixturing hole 307, (ii) second bush 306 is un-rotatable with respect to fixturing hole 307, and (iii) first bush 305 is un-rotatable with respect to second bush 306.

According to some embodiments, adaptive fixturing mechanism 300 further includes one or more locking members 303a/b that lock one or more components of fixturing mechanism 300 with respect to first structural member 304a and a second structural member 304b.

According to some embodiments, in the locked state, first locking member 303a is coupled to first structural member 304a. In some embodiments, in the locked state, second locking member 303b is coupled to second structural member 304b. According to some embodiments, locking aperture 303d is non-circular (e.g. oval or polygonal). In some embodiments, the non-circular shape and size of locking aperture 303d is adapted to fit a non-circular head of one or more of the first and the second bush 305, 306.

In some embodiments, the locking member 303 may include an attachment hole 303c for coupling to first or second structural member 304a, 304b using fastener 301. In some embodiments, fastener 301 has a non-circular head. In some embodiments, first or second locking member 303a or 303b has a fastener hole 308 for coupling fastener 301 to first or second locking member 303a or 303b. In some embodiments, nut 302 is used to secure first and/or second locking member 303a/b, and fastener 301.

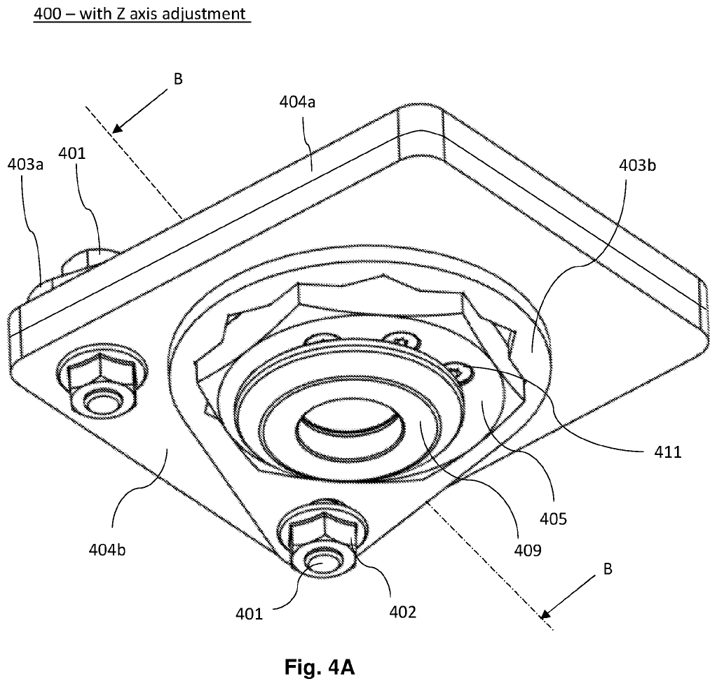

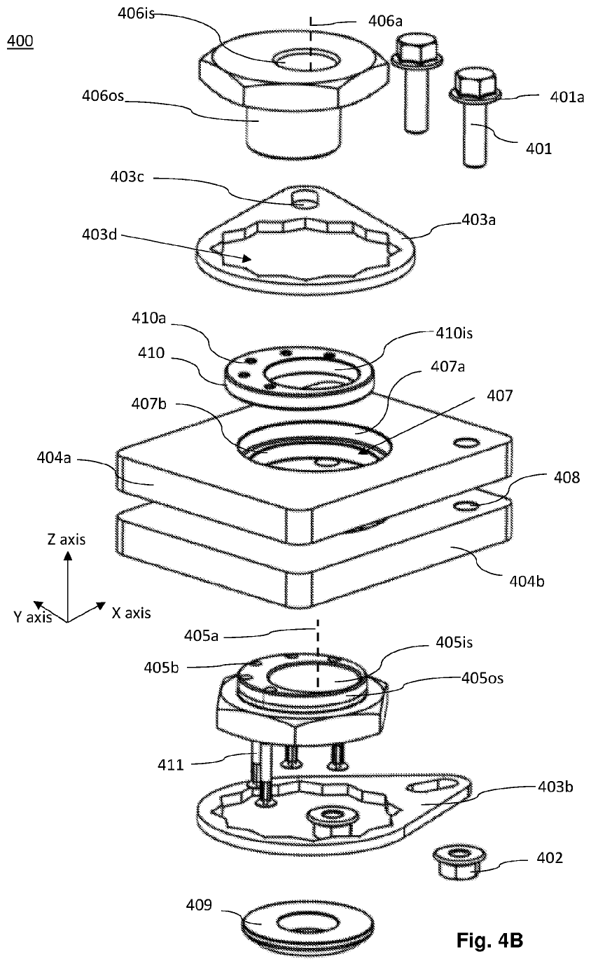

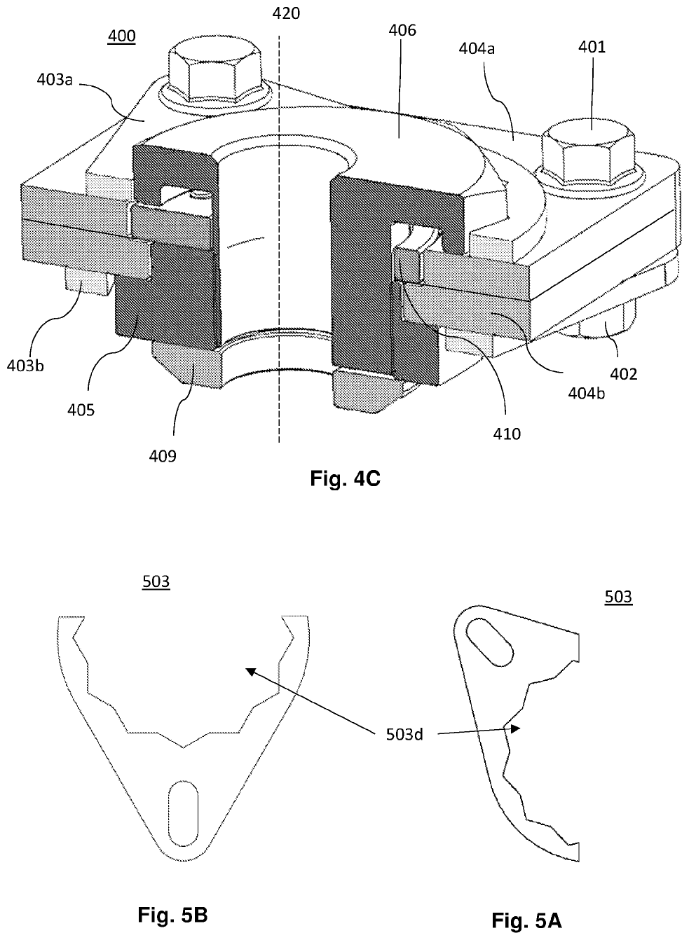

Reference is now made to FIGS. 4A, 4B and 4C which are three-dimensional (3D) (perspective) diagrams showing a non-limiting example of a fixturing mechanism 400. FIG. 4A shows a bottom perspective view of the fixturing mechanism 400. FIG. 4B shows an exploded view of fixturing mechanism 400, and FIG. 4C shows a perspective partial longitudinal section view of fixturing mechanism 400 along line BB of FIG. 4A.

Fixturing mechanism 400 may comprise a mechanism that allows to free tolerance in applications that need to free tolerances on three different axes (for example, x, y and z axis) due to inaccurate manufacturing and high tolerance build ups.

According to some embodiments, as shown in FIGS. 4A, 4B and 4C the first structural member 404a has a fixturing hole 407 and a locking disk 410 adapted to fit within fixturing hole 407. According to some embodiments, fixturing hole 407 is shaped to have an internal step to support locking disk 410 from moving in the z direction (e.g. direction which is parallel to the first and second eccentric axes). In some embodiments, as shown in FIG. 4B, fixturing hole 407 is divided to have two different diameters-a large diameter 407a and a small diameter 407b, such that a step support surface is created. In some embodiments, at the locked state or at a locked state, locking disk 410 is assembled within the large diameter fixturing hole 407a and locking disk 410 is coupled to first eccentric bush 405 or second eccentric bush 406. According to some embodiments, locking disk 410 is secured to first eccentric bush 405 or second eccentric bush 406 by a disk fastener 411. In some embodiments, at the locked state, disk fastener 411 locks locking disk 410 to be un-rotatable with respect to one or more of first and second bush 405/406. In some embodiments, disk fastener 411 locks locking disk 410 to be un-rotatable with respect to one or more of first and second bush 405/406, preventing the moving of either or both the first and second eccentric bushes 405, 406 on the z axis.

According to some embodiments, in an unlocked assembled state and/or in a locked state, an inner hole 410is of locking disk 410 is disposed to be facing the outer surface 406os of the second bush 406.

Similar to adaptive fixturing mechanism 300, cylindrical second bush 406 has an inner hole 406is having a second eccentric axis 406a relative to second bush outer surface 406os and cylindrical first bush inner hole 405is has a first eccentric axis 405a relative to first bush outer surface 405os.

In operation, while in an unlocked assembled state, by rotating first bush 405 and/or second bush 406, the position of eccentric axis 406a changes. It means that the location of eccentric axis 406a may be dynamic and allow to free tolerance on a plane (e.g. plane X-Y).

According to some embodiments, inner hole of first bush 405is has an internal thread, and the outer surface of a second eccentric bush 406os has an external thread. In operation, in the unlocked assembled state, the inner hole 405is of the first bush 405 and the outer surface 406os of the second eccentric bush 406are connected to each other and define an unlocked assembled state of first and second structural members 404a/404b with respect to each other on plane X-Y.

After finding the right location in plane X-Y, when keeping first bush 405 and/or second bush 406 fixed in position, rotating the other bush for 360 degrees the position of the axis stays the same about plane X-Y and the position in direction z (e.g. direction which is parallel to first or second eccentric axis) changes and allows to free tolerance.

According to some embodiments, adaptive fixturing mechanism 400 further includes one or more locking members 403a/b that lock one or more components of fixturing mechanism 400 with respect to first structural member 404a and a second structural member 404b. According to some embodiments, while in a locked state, first locking member 403a is coupled to first structural member 404a and second locking member 403b is coupled to second structural member 404b to lock the correct position of first bush 405 and the second bush 406. Fastener 401 is inserted into attachment hole 403c of first or second locking member 403a or 403b and into fastener hole 408 of first structural member 404a and second structural member 404b. Nut 402 ensures that first and second locking member 403a ,403b which does not move while fastener head 401a is disposed to be facing and pushing against first locking member 403a. A washer 409 can be located between the first bush 405 and a fastener to lock the whole fixturing mechanism. According to some embodiments, locking aperture 403d is non-circular (e.g. oval or polygonal). In some embodiments, the non-circular shape and size of locking aperture 403d is adapted to fit a non-circular head of one or more of the first and the second bush.

Reference is now made to FIGS. 5A and 5B which are schematic views of examples of open locking members that can be inserted into place from the side regardless of the assembly order. Locking member 503 is used at the locked state of any one of the fixturing mechanisms described elsewhere above. Similar to locking members 303 and 403, locking member 503 has a locking aperture 503d for fitting on the first or second bushing to restrict their rotation about their respective eccentric axes. According to some embodiments, locking aperture 503d is non-circular (e.g. oval or polygonal). In some embodiments, the non-circular shape and size of locking aperture 503d is adapted to fit a non-circular head of one or more of the first and the second bush. As shown in FIGS. 5A-5B, locking aperture 503d defines at least a portion open for sliding sideway onto one of the first and second bush.

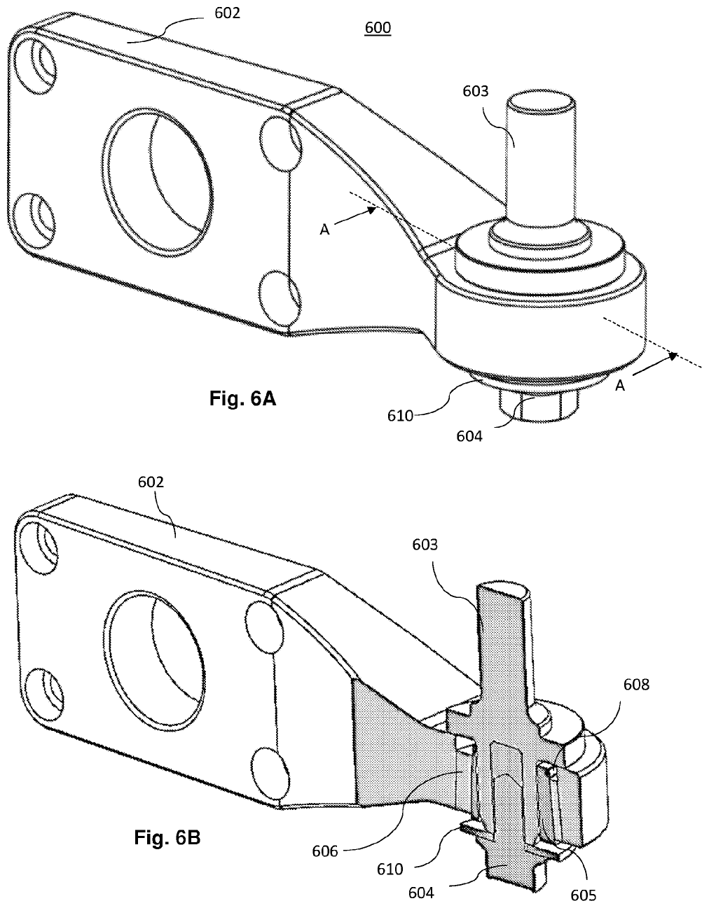

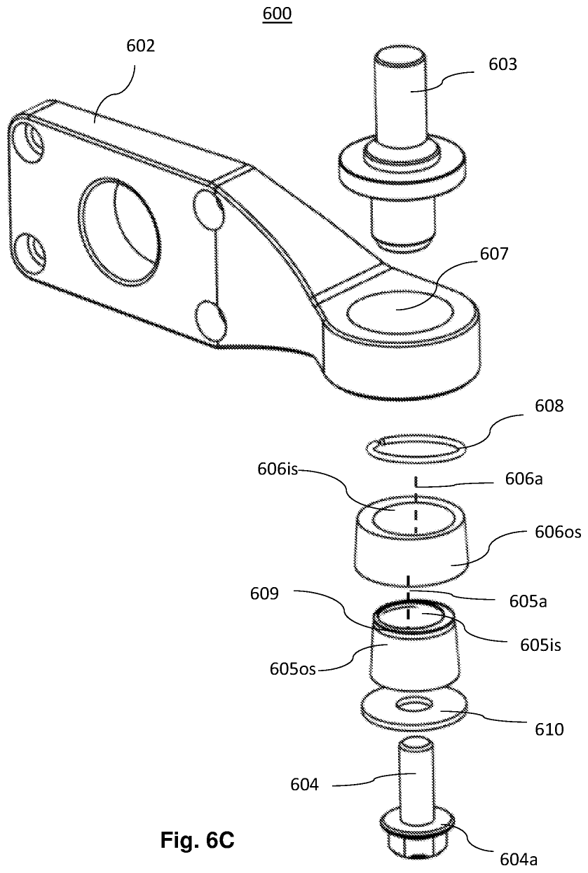

Reference is now made to FIGS. 6A, 6B, and 6C, which are 3D (perspective) diagrams showing a non-limiting example of a fixturing mechanism 600. According to some embodiments of the invention, FIG. 6A shows a perspective view of fixturing mechanism 600, and FIG. 6B shows a perspective partial longitudinal section view of fixturing mechanism 600 along line AA of FIG. 6A.

Fixturing mechanism 600 may be a mechanism that allows to free tolerance in applications that need to free tolerance due to inaccurate manufacturing and high tolerance build ups.

Fixturing mechanism 600 may include a base portion 602 to accommodate one or more components of fixturing mechanism 600 and to connect two structural members together. Base portion 602 may include a conical fixturing hole 607 wherein the diameter of one side of the fixturing hole is smaller than the diameter of the other side of the fixturing hole. First bush 605 and second bush 606 are hollow conical eccentric bushes adapted to be located one inside the other and within fixturing hole 607.

According to some embodiments, first bush 605 has a cylindrical first bush inner hole 605is having a first eccentric axis 605a relative to the first bush outer surface 605os. According to some embodiments, second bush 606 has a conical second bush inner hole 606is having a second eccentric axis 606a relative to second bush outer surface 606os. In operation, second bush 606 is inserted into fixturing hole 607 from the bigger side of the conical fixturing hole 607. Conical fixturing hole is used to describe a frustum-shaped (as used herein, ‘conical’ is equivalent to (frustum-shaped') fixturing hole and conical eccentric bushes are used to describe a frustum shape bushes. First bush 605 is inserted into second bush 606 from the bigger side of the second bush 606. By rotating the first bush 605 and the second bush 606 on with respect to the other, the position of the first eccentric axis 605a changes. It means that the location of first eccentric axis 605a is dynamic and allow to free tolerance on a plane.

According to some embodiments, the minimum diameter of the second bush outer surface 606os is bigger than the minimum diameter of the cone shape fixturing hole 607. In some embodiments. the maximal diameter of the first bush outer surface 605os is bigger than the maximum diameter of the second bush inner hole 606is. In some embodiments. the first bush outer surface 605os and the second bush inner hole 606 in has a similar slope as the slope of the second bush outer surface 606os. In some embodiments. the slope of fixturing hole 607. Such shape may increase the contact surface between the first and second bushes and between the second bush outer surface 606os and fixturing hole 607.

Fixturing mechanism 600 has two assembled states—an unlocked state and a locked state. In the unlocked assembled state the first bush 605 is assembled within the second bush inner hole 606is and the second bush 606 is inserted within the fixturing hole 607, such that the second bush conical outer surface 606os facing the fixturing hole 607 and the second bush conical inner hole 606is facing an outer conical surface of a first bush 605os and both first bush and second bush are each rotatable about their respective eccentric inner fixturing hole axes.

In the locked state the first bush 605 is pressed within the second bush 606 in the direction of the second eccentric axis until the first bush outer surface 605os is urged against the inner hole of the second bush 606is and the second bush 606 is pressed within the fixturing hole 607 until the second bush outer surface 606os is urged against the fixturing hole 607, such that the first bush and second bush are locked by friction between the surfaces from being rotatable about their respective eccentric inner fixturing hole axes.

According to some embodiments, the fixturing mechanism 600 can include a pin 603. Pin 603 may be used to couple a second structural member with base portion 602. In some embodiments, pin 603 is coupled or is a portion of the second structural member. In some embodiments, first portion of pin 603 is hollow with an internal thread that can be used to lock the fixturing mechanism 600 in a locked state. In some embodiments, the first portion of pin 603 may be inserted into inner hole 605is of first bush 605.

According to some embodiments, the fixturing mechanism 600 is used to couple base 602 to a vehicle. In some embodiments, pin 603 has a second portion coupled to a reference frame 800 (for example chassis or body) of the vehicle. In some embodiments, second portion of pin 603 may be welded or fastened to a structural member that needs to be connected to base 602 (e.g. the second portion of pin 603 can be weld to a chassis).

Second bush 606 may include groove 609 for a round wire 608. Round wire 608 may connect the bushes 606 and 605 together. After finding the correct location of bush axis 605a, pin 603 may inserted from one side of base 602 into the inner hole of the first bush 605is. Washer 610 and fastener 604 may be inserted from the second portion of base 602 to lock the correct position of a first eccentric axis 605a. The fastener 604 may have a shoulder 604a adapted to push the first bush 605 within the second bush 606 in the direction of the second eccentric axis.

According to some embodiments, there is a structural frame having a plurality of structural positioning and fixturing holes. For example, the frame may have a first positioning hole, a second oval shaped hole, and one or more fixturing holes. The adaptive fixturing mechanism described elsewhere herein may be used to lock the structural frame with another structural component, for example to deal with manufacturing tolerances or errors.

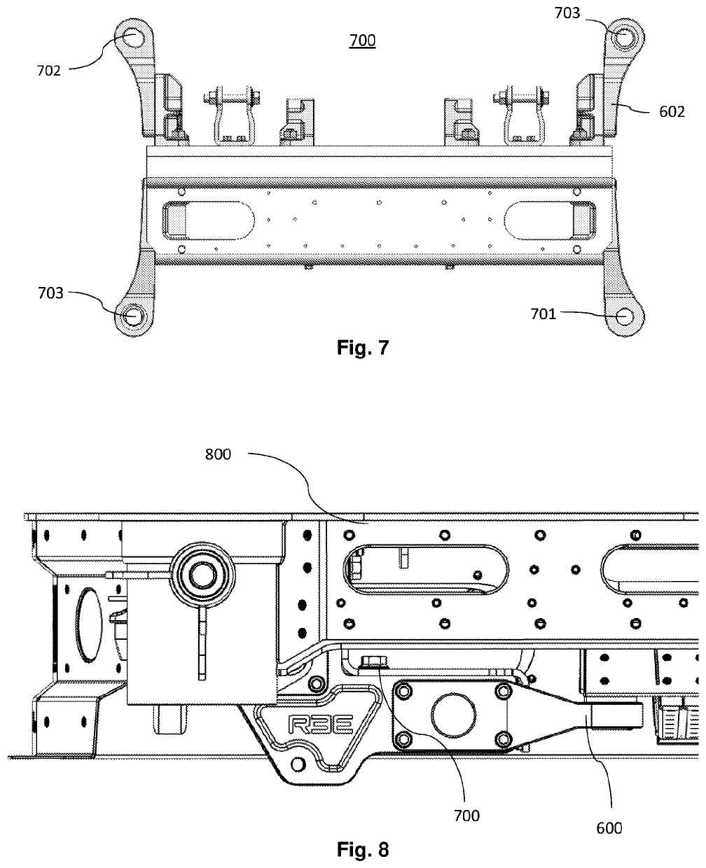

Reference is now made to FIG. 7. Sub-frame 700 is an example of using a fixturing mechanism as described elsewhere above (e.g. 300, 400 and 600) to deal with inaccurate manufacturing and high tolerance build ups. Positioning fixturing hole 701 is the first fixturing hole to fix in place while assembling sub-frame 700. In some embodiments, oval shaped attachment hole 702 is the second fixturing hole to fix. While fixturing holes 701 and 702 are fixed in place, the whole sub-frame 700 is fixed. The correct location of the other fixturing holes of sub-frame 700 is defined by the first two fixturing holes (in this case fixturing hole 701,702). To get to this correct location, fixturing hole 703 is using the fixturing mechanism 300,400 or 600. By rotating the first bush and the second bush of the fixturing mechanism, fixturing hole 703 can move to the correct position.

Reference is now made to FIG. 8, which is an example of connecting two structural members of a vehicle. The first structural member is a reference frame 800 (for example chassis or body) which is connecting to the second structural member, sub-frame 700 by fixturing mechanism 600. In some embodiments, sub-frame 700 is a structural member of a vehicle corner assembly.

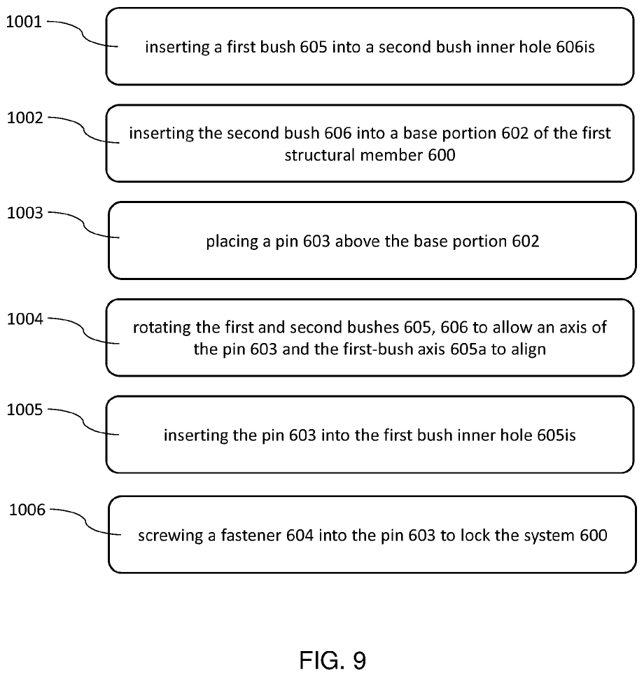

Referring now to FIG. 9, a method is disclosed, according to some embodiments, for coupling structural members. The method employs a coupling system according to any of the embodiments disclosed herein. As illustrated by the flowchart in FIG. 9, the method comprises at least Steps 1001, 1002, 1003, 1004, 1005, and 1006.

Step 1001 includes inserting a first bush 605 into a second bush inner hole 606is.

Step 1002 includes inserting the second bush 606 into a conical fixturing hole 607 of the first structural member 600.

Step 1003 includes placing a pin 603 above the conical fixturing hole 607, e.g., proximate to the base portion 602.

Step 1004 includes rotating the first and second bushes 605, 606 to allow an axis of the pin 603. and the first-bush axis 605a to align.

Step 1005 includes inserting the pin 603 into the first bush inner hole 605is.

Step 1006 includes screwing a fastener 604 into the pin 603 to lock the system 600.

In some embodiments, not all of the steps are carried out and the steps may be carried out in any suitable order.

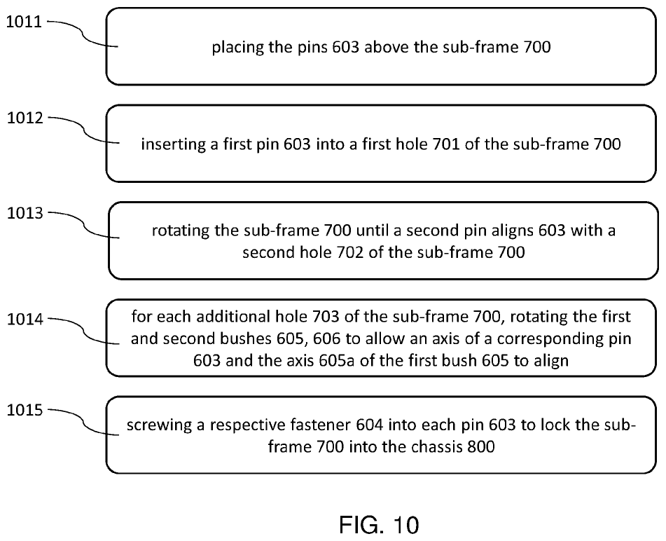

Referring now to FIG. 10, a method is disclosed, according to some embodiments, for coupling a sub frame to a chassis. The method employs a coupling system according to any of the embodiments disclosed herein. As illustrated by the flowchart in FIG. 10, the method comprises at least Steps 1011, 1012, 1013, 1014 and 1015.

Step 1011 includes placing the pins 603 above the sub-frame 700, e.g., proximate to the sub-frame 700.

Step 1012 includes inserting a first pin 603 into a first hole 701 of the sub-frame 700.

Step 1013 includes rotating the sub-frame 700 until a second pin aligns 603 with a second hole 702, which is oval-shaped, of the sub-frame 700.

Step 1014 includes, for each additional hole 703 of the sub-frame 700, rotating the first and second bushes 605, 606 to allow an axis of a corresponding pin 603 and the axis 605a of the first bush 605 to align.

Step 1015 includes screwing a respective fastener 604 into each pin 603 to lock the sub-frame 700 into the chassis 800.

In some embodiments, not all of the steps are carried out and the steps may be carried out in any suitable order.

### Discussion of Additional Embodiments

As used herein, the term ‘fixate’ and its conjugates such as, for example, ‘fixation’, mean attach, connect, join, lock in place, and the like, with regard to one, two or more mechanical members, including the attachment, connection, joining, etc., of one mechanical element to another, regardless of whether the connecting, attaching, joining, etc., is permanent or reversible.

According to an aspect of some embodiments of the present invention there is provided a system, i.e., a mechanism, for fixating structural members when having tolerances in at least one dimension. The system may include: a structural member with a fixturing hole, two eccentric hollow bushes, a first bush and a second bush. In some embodiments, the first bush has a cylindrical first bush outer surface and a cylindrical first bush inner hole with a first eccentric axis, which is eccentric relative to the first bush outer surface. In some embodiments, the second bush has a cylindrical second bush outer surface and a cylindrical second bush inner hole with a second eccentric axis, which is eccentric relative to the second bush outer surface.

According to some embodiments of the invention, a rotation of the first and the second bushes changes the location of both, the first eccentric axis and the second eccentric axis.

According to some embodiments of the invention, when the adaptive fixturing mechanism is in a pre-fixation state, i.e., an assembled state, the second bush is assembled within the first bush inner hole and the first bush is inserted within the fixturing hole, such that the first bush outer surface faces the fixturing hole and the first bush inner hole faces the outer surface of a second bush and both the first bush and the second bush are each rotatable about their respective eccentric inner fixturing hole axes.

According to some embodiments of the invention, one or more of the first and the second bush comprises a non-circular head.

According to some embodiments of the invention, the adaptive fixturing mechanism comprises a first locking member for fixating the first bush in a locked state in which the first bush is un-rotatable with respect to the fixturing hole.
In some embodiments of the invention, the adaptive fixturing mechanism comprising a second locking member for fixating the second bush at a locked state in which the second bush is un-rotatable with respect to the fixturing hole.

In some embodiments of the invention, the adaptive fixturing mechanism comprises a first and a second locking member for fixating the first and the second bush in a locked state in which both are un-rotatable with respect to the fixturing hole. In some embodiments, the locking member comprises a non-circular locking aperture. In some embodiments, one or more of a first and a second locking members has a portion open for sliding sideway onto one of the first and second bush for locking a rotation of the first and second bush with respect to the fixturing hole. According to some embodiments of the invention, the adaptive fixturing mechanism comprises a locking disk adapted fit within the fixturing hole and having a locking disk hole for a disk fastener and wherein at a locked state, the disk fastener locks the locking disk to be un-rotatable with respect to the first and/or second bush.

In some embodiments, the fixturing hole has an internal step, and at the locked state, the locking disk fits within the fixturing hole such that the internal step supports the locking disk from moving in a direction parallel to the first or the second eccentric axis.

According to some embodiments of the invention, the inner hole of the first bush has an internal thread and the outer surface of a second bush has an external thread such that first bush and second bush can be coupled to each other and adapt a respective position with respect to each other along a direction parallel to the first or the second eccentric axis.

According to some embodiments of the invention, at a locked state the locking disk is fastened to the first bush.

According to some embodiments of the invention, the structural member is a sub-frame, having a plurality of holes, wherein at least one of the holes is a positioning fixturing hole. According to some embodiments of the invention, at least one of the holes is an oval shaped attachment hole. According to some embodiments of the invention, at least one of the holes is the fixturing hole.

According to an aspect of some embodiments of the present invention there is provided an adaptive fixturing mechanism. The mechanism may include: a base having a cone shaped fixturing hole, a conical eccentric hollow first bush having a conical first bush outer surface and a cylindrical first bush inner hole with a first eccentric axis relative to the first bush outer surface. The mechanism may further include a second bush having a conical second bush outer surface and a conical second bush inner hole with a second eccentric axis relative to the second bush outer surface. According to some embodiments of the invention, the minimum diameter of the second bush outer surface is bigger than the minimum diameter of the cone shape fixturing hole. According to some embodiments of the invention, the maximal diameter of the first bush outer surface is bigger than the maximum diameter of the second bush inner hole.

According to some embodiments of the invention, the first bush outer surface has a similar slope as the second bush inner hole, and the second bush outer surface has a similar slope as the fixturing hole.

According to some embodiments of the invention, the adaptive fixturing mechanism comprises a pre-fixation state wherein the first bush is assembled within the second bush inner hole and the second bush is inserted within the fixturing hole, such that the second bush conical outer surface faces the fixturing hole and the second bush conical inner hole faces the outer conical surface of a first bush, and both first bush and second bush are each rotatable about their respective eccentric inner fixturing hole axes.

According to some embodiments of the invention, the adaptive fixturing mechanism comprises a locked state wherein the first bush is pressed within the second bush in the direction of the second eccentric axis until the first bush outer surface is urged against the inner hole of the second bush, and the second bush is urged against the fixturing hole, such that the first bush and second bush are locked from being rotatable about their respective eccentric inner fixturing hole axes. According to some embodiments of the invention, the adaptive fixturing mechanism comprises a pin having a first portion with an internal thread and adapted to be inserted within the first bush inner hole. In some embodiments, a second portion of the pin is fixed to a chassis. In some embodiments, the adaptive fixturing mechanism comprises a screw like fastener with external thread which may inserted into a hollow portion of the pin. In some embodiments, the fastener has a shoulder adapted to push the first bush within the second bush inner hole in the direction of the second eccentric axis. In some embodiments, the adaptive fixturing mechanism comprises a washer that located between the fastener shoulder and the first bush.

According to some embodiments of the invention, a location of an eccentric axis changes due to the rotation of the first and the second bushes. In some embodiments, the adaptive fixturing mechanism comprises a round wire connecting the first bush to the second bush. In some embodiments, the adaptive fixturing mechanism comprises a groove on the first and second bushes for easier fastening.

According to an aspect of some embodiments of the present invention there is provided a frame having a first hole positioning hole, a second oval shaped hole, and one or more holes having the adaptive fixturing mechanism inserted therein, which may resolve manufacturing errors while positioning the sub-frame.

The terms “comprises”, “comprising”, “includes”, “including”, “has”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

Unless otherwise indicated, numbers used herein and any number ranges based thereon are approximations within the accuracy of reasonable measurement and rounding errors as understood by persons skilled in the art. The term ‘substantially’ as used herein and in the claims appended hereto means within ±1%, or within +2%, or within ±3%, or within ±4%, or within ±5%, or within ±6%, or within ±7%, or within ±8%, or within ±9%, or within ±10%.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

1. A system for coupling two structural members, the system comprising:
a first eccentric hollow bush comprising a cylindrical first-bush outer surface and a cylindrical first-bush inner hole having a first eccentric axis, the first eccentric axis being eccentric relative to the first-bush outer surface, and
a second eccentric hollow bush comprising a cylindrical second-bush outer surface and a cylindrical second-bush inner hole having a second eccentric axis, the second eccentric axis being eccentric relative to the second-bush outer surface,
wherein, when the system is in an unlocked assembled state, (i) the second bush is disposed within the first-bush inner hole such that the first bush inner hole faces an outer surface of the second bush, (ii) the first bush is inserted in respective opposing fixturing holes of the two structural members such that the first-bush outer surface faces the fixturing holes, and (iii) the first bush is rotatable about the first and second fixturing holes axes and the second bush is rotatable about the first eccentric axis.

2. The system of claim 1, wherein, when the system is in the unlocked assembled state, a rotation of both the first and the second bushes changes the location of both the first eccentric axis and the second eccentric axis.

3. The claim of either one of claims 1-2, wherein the system is effective to reduce a total tolerance relative to a combined manufacturing tolerance of respective fixturing holes of the two structural members.

4. The system of any one of the preceding claims, comprising respective first and second locking members for placing the first and second bushes in a locked state in which the first bush and second bushes are un-rotatable with respect to the fixturing holes.

5. The system of any one of the preceding claims, wherein at least one of the first and second bushes comprises a non-circular head.

6. The system of either one of claims 4-5, wherein the locking member comprises a non-circular locking aperture.

7. The system of any one of claims 4-6, wherein at least one of the first and second locking members has a portion open for sliding sideways onto a respective one of the first and second bushes for locking a rotation of the respective one with respect to the fixturing holes.

8. The system of any one of the preceding claims, comprising:
a locking disk adapted to fit within at least one of the two respective fixturing holes, the locking disk having a locking disk hole for receiving one or more portions of a disk fastener, wherein when the system is in the assembled state, the disk fastener locks the locking disk to be un-rotatable with respect to the first and/or the second bush.

9. The system of claim 8, wherein (i) the at least one fixturing hole has an internal step, and the locking disk fits within the at least one fixturing hole such that the internal step constrains the locking disk from moving in a direction parallel to the first and the second eccentric axes.

10. The system of any one of the preceding claims, wherein:
the inner hole of the first bush has an internal thread and the outer surface of a second bush has an external thread, such that the first and second bushes are threadedly couplable to each other to adapt a respective position with respect to each other along a direction parallel to the first and second eccentric axes.

11. The system of any one of claims 8-10, wherein when the system is in the assembled state, the locking disk is fastened to the first bush.

12. The system of any one of the preceding claims, wherein a first of the two structural members comprises a sub-frame and comprises a positioning fixturing hole, an oval-shaped attachment hole, and the fixturing hole.

13. A system for adaptive coupling of two structural members, the system comprising:
a first eccentric hollow bush comprising a conical first-bush outer surface and a cylindrical first-bush inner hole having a first eccentric axis, the first eccentric axis being eccentric relative to the first-bush outer surface; and
a second eccentric hollow bush having a conical second-bush outer surface and a conical second-bush inner hole having a second eccentric axis, the second eccentric axis being eccentric relative to the second-bush outer surface,
wherein:
a minimum diameter of the second-bush outer surface is bigger than a minimum diameter of a conical fixturing hole,
a maximal diameter of the first bush outer surface is bigger than a maximum diameter of the second bush inner hole, and
when the system is in an unlocked assembled state, (i) the first bush is assembled within the second bush inner hole such that the conical first-bush outer surface faces the conical second-bush inner hole; (ii) the second bush is inserted within the conical fixturing hole, such that the conical second-bush outer surface faces the conical fixturing hole, and (iii) the first bush is rotatable about the second bush eccentric axis and the second bush is rotatable about the conical fixturing hole axis.

14. The system of claim 13, wherein the system is effective to reduce a total tolerance relative to a combined manufacturing tolerance of respective fixturing holes of the two structural members.

15. The system of either one of claims 13-14, wherein the first bush outer surface has substantially the same slope, or is within ±5% or ±10% of having the same slope, as the second bush inner hole, and the second bush outer surface has substantially the same slope, or is within ±5% or ±10% of having the same slope, as the conical fixturing hole.

16. The system of any one of claims 13-15, wherein when in an assembled state, the first bush is pressed within the second bush in a direction parallel to the second eccentric axis until the first bush outer surface is urged against the inner hole of the second bush, and the second bush is urged against the conical fixturing hole, such that the first bush and second bush are locked from being rotatable about their respective rotation axes.

17. The system of any one of claims 13-16, comprising a pin having a first portion with an internal thread and adapted to be inserted within the first-bush inner hole.

18. The system of claim 17, wherein a second portion of the pin is fixed to a chassis.

19. The system of either one of claims 17-18, comprising a fastener with an external thread shaped for insertion into a hollow portion of the pin.

20. The system of claim 19, wherein the fastener has a shoulder adapted to push the first bush within the second bush inner hole in the direction parallel to the second eccentric axis.

21. The system of claim 20, comprising a washer disposed between the fastener shoulder and the first bush.

22. The system of any one of claims 13-21, wherein when in the unlocked assembled state, the respective locations of the first and second eccentric axes change when the first and second bushes are rotated.

23. The system of any one of claims 13-22, comprising a round wire connecting the first bush to the second bush, and a groove on the first bush configured for receiving the round wire.

24. A frame comprising: a first positioning hole, an oval-shaped hole, and one or more fixturing holes according to any one of claims 13-23 therein.

25. A method of coupling structural members employing the system of any one of claims 13 to 23 in the unlocked assembled state, the method comprising:
a. inserting a first bush into a second bush inner hole;
b. inserting the second bush into a base portion of the first structural member;
c. placing a pin of the second structural member above the base;
d. rotating the first and second bushes to allow an axis of the pin and the first-bush axis to align;
e. inserting the pin into the first bush inner hole; and
f. screwing a fastener into the pin to lock the system.

26. The method of claim 25, wherein the round wire connects the first bush to the second bush.

27. The method of claim 26, wherein the washer is inserted between the fastener and the first bush.

28. A method of coupling a sub frame to a chassis, the chassis comprising one or more pins, the sub-frame comprising the system of any one of claims 13 to 23 in the unlocked assembled state, the method comprising:
a. placing the pins above the sub-frame;
b. inserting a first pin into a first hole of the sub-frame;
c. rotating the sub-frame until a second pin aligns with a second hole of the sub-frame;
d. for each additional hole of the sub-frame, rotating the first and second bushes to allow an axis of a corresponding pin and the axis of the first bush to align; and
e. screwing a respective fastener into each pin to lock the sub-frame into the chassis.

29. The method of claim 28, wherein the second hole of the sub-frame is oval-shaped.

30. The method of claim 28, wherein the system is configured to enable reversing the locking.
